(19) United States
(12) Patent Application Publication
(10) Pub. No.: US 2024/0402032 A1
(43) Pub. Date: Dec. 5, 2024

(54) FIBER OPTICS INTEGRATED WITH NUMERICAL SIMULATORS FOR PIPELINE LEAK QUANTIFICATION

(71) Applicant: Cameron International Corporation, Houston, TX (US)

(72) Inventors: Kang Wang, Shanghai (CN); Shu Pan, Calgary (CA); Nasser Ghorbani, Menlo Park, TX (US); Adnan Chughtai, Crawley (GB); Jason Reynaud, Houston, TX (US); XingXing Cai, Beijing (CN); Taoufik Wassar, Houston, TX (US)

(21) Appl. No.: 18/734,436

(22) Filed: Jun. 5, 2024

(30) Foreign Application Priority Data
Jun. 5, 2023 (CN) 202310655625.0

(51) Int. Cl. G01M 3/04; G01H 9/00; G01K 11/32; G01M 3/24; G08B 21/18

(52) U.S. Cl. CPC G01M 3/047; G01H 9/004; G01K 11/32; G01M 3/243; G08B 21/182

(57) ABSTRACT

A system includes a fiber optic cable configured to detect one or more first parameters of a leak event along a fluid conduit, and one or more sensors configured to measure one or more second parameters of a fluid flow along the fluid conduit. The system also includes a controller including a processor, a memory, and instructions stored on the memory and executable by the processor to: detect the one or more first parameters of the leak event via the fiber optic cable, measure the one or more second parameters of the fluid flow via the one or more sensors, input the one or more first parameters and the one or more second parameters into a model configured to simulate operation with the fluid conduit, and output leak information corresponding to the leak event via execution of the model.

### CROSS-REFERENCE TO RELATED APPLICATION

This application claims priority to and the benefit of CN Application Serial No. 202310655625.0, entitled “Fiber Optics with Numerical Simulators for Pipeline Leak Quantification,” filed Jun. 5, 2023, which is hereby incorporated by reference in its entirety for all purposes.

### BACKGROUND

The present disclosure generally relates to quantification of pipeline leaks, and more particularly to integrating fiber optics and numerical simulators for quantification of pipeline leaks.

Oil and gas pipeline networks are generally considered the most economical and safest means of transporting crude oil with high efficiency and reliability. However, in recent decades, the number of critical accidents due to pipeline failures continues to increase. Such failures can be intentional (e.g., vandalism) or unintentional (e.g., equipment/material failure and corrosion) damages, resulting in devastating and irreversible impact, such as ecological disasters, financial loss, and extreme environmental pollution. The impact of pipeline failures may increase when a pipeline leakage is not detected promptly. Accordingly, new methods for pipeline leakage and quantification may be desirable.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a method includes detecting a leak event using fiber optic sensing, and evaluating the leak event using a numerical simulator.

In certain embodiments, a method includes preparing a base simulation case in which no leak is present, detecting a leak event using fiber optic sensing, feeding a location of the leak into a numerical simulator, and running parametric studies with the location of the leak to identify a size and rate of the leak.

In certain embodiments, a method includes preparing a base simulation case in which no leak is present, generating a large database by running parametric study simulations, building a reduced order machine learning model from the database, detecting a leak using fiber optic sensing, and feeding a location of the leak into the reduced order machine learning model. The method can further include using predicted results to run a forward model to further validate interpretations and forecast upcoming variations.

In certain embodiments, a system includes a fiber optic cable configured to detect one or more first parameters of a leak event along a fluid conduit, and one or more sensors configured to measure one or more second parameters of a fluid flow along the fluid conduit. The system also includes a controller including a processor, a memory, and instructions stored on the memory and executable by the processor to: detect the one or more first parameters of the leak event via the fiber optic cable, measure the one or more second parameters of the fluid flow via the one or more sensors, input the one or more first parameters and the one or more second parameters into a model configured to simulate operation with the fluid conduit, and output leak information corresponding to the leak event via execution of the model.

In certain embodiments, a method includes detecting one or more first parameters of a leak event via a fiber optic cable along a fluid conduit, and measuring one or more second parameters of a fluid flow along the fluid conduit via one or more sensors. The method also includes inputting the one or more first parameters and the one or more second parameters into a model configured to simulate operation with the fluid conduit, and outputting leak information corresponding to the leak event via execution of the model

In certain embodiments, a non-transitory, tangible, computer readable medium includes instructions that, when executed by a processor, causes the processor to perform operations including detecting one or more parameters of a leak event via a fiber optic cable along a fluid conduit, where the one or more first parameters includes a leak location, and measuring one or more second parameters of a fluid flow along the fluid conduit via one or more sensors. The operations also include inputting the one or more first parameters and the one or more second parameters into a model configured to simulate operation with the fluid output, and outputting leak information corresponding to the leak event via execution of the model, where the leak information includes a leak quantification of the leak event corresponding to the leak location, and where the leak quantification includes a leak size, a leak flow rate, or a combination thereof.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an example pipeline system;

FIG. 2 is a schematic view of an example pipeline monitoring system that could be used in the pipeline system of FIG. 1, according to an embodiment of the present disclosure;

FIG. 3 is a block diagram of an example process for integrating fiber optics and numerical simulation, according to an embodiment of the present disclosure;

FIG. 4 is a schematic view of an example simulation case for pipeline leak monitoring using the process of FIG. 3, according to an embodiment of the present disclosure;

FIG. 5 is a graph of inlet pressure over time for the simulation case of FIG. 4 with leak diameters ranging from 2% to 20%, according to an embodiment of the present disclosure;

FIG. 6 is a graph of outlet flowrate over time for the simulation case of FIG. 4 with a range of different leak diameters, according to an embodiment of the present disclosure;

FIG. 7 is a graph of leak flowrate over time for the simulation case of FIG. 4 with a range of different leak diameters, according to an embodiment of the present disclosure;

FIG. 8 is a graph of pressure variation along the pipeline of the simulation case of FIG. 4 with a range of different leak diameters under steady state conditions, according to an embodiment of the present disclosure; and

FIG. 9 is a block diagram of an example process for integrating fiber optics and numerical simulation in real time by generating reduced order models.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Substantial research efforts have been devoted to developing and implementing various approaches for oil and gas pipeline leak detection and localization. Two specific approaches are fiber optics sensing and dynamic numerical simulation.

Remote fiber optic sensing technologies are routinely used to mitigate leak events or identify leak locations, such that operators may swiftly take data-driven actions to minimize the severity of the respective leak event. This technology requires installation of fiber optic sensors along the exterior of a respective pipeline. For example, fiber optic sensors may be embedded or placed in close proximity to a material, which is affected by the presence of a fluid (e.g., water, oil, gas, etc.), such as any suitable polymer, metal, ceramic, gel, or combination thereof, and the like. The material may be applied as a coating to the fiber optic sensors, and may undergo a change such as swelling, shrinking, dissolving, or any other suitable reaction in response to the presence of the fluid. The change in the material may affect the fiber optic sensors by increasing or reducing the strain on the fiber, or by causing a chemical reaction with the fiber. Accordingly, when pipeline leakage occurs and hydrocarbon fluid affects the coating material, the fiber optic sensors may detect acoustic and temperature anomalies associate with the leak. Fiber optic sensing is universally applicable to above-ground gathering networks, buried transcontinental oil and gas transmission pipelines, and suitable for all fluid types.

Dynamic numerical simulation is a computational method that generally requires sensor measurement(s) of pressure, flowrate, and temperature at a few locations along a respective pipeline. Accordingly, the dynamic numerical simulation executes numerical simulation software via one or more processor-based computing systems, using a combination of inputs from discrete sensors at various positions along the pipeline (e.g., at 50-kilometer intervals, at the inlet and outlets of pipeline components, etc.), for example provided by a supervisory control and data acquisition (SCADA) system. Mathematical models are formulated to represent operation of a pipeline system based on physics principals, such as conservation of mass. During operation of the pipeline system, the mathematical models are calibrated to match the measured data, thereby functioning as real-time models of the pipeline system. Therefore, these computationally intensive simulations may be performed to detect leaks in the pipeline system based on discrepancies between the measured data and simulated data based on conservation equations and equations of state for the fluid. That is, once the mathematical models are calibrated for the pipeline system, deviations between the simulated data and the measured data may indicate leakage events, as the mathematical models simulate normal operations and thus do not capture anomalies caused by physical events. This process is sometimes referred to as real time transient modeling (RTTM).

However, remote fiber optic sensing and dynamical numerical simulation have limitations regarding leak detection and localization. For example, when fiber optic sensing detects a leak event, it may report a relatively accurate leak location (e.g., within a few meters of accuracy), but it may be unable to physically interpret the size of the leak and the severity of the event. Conversely, a numerical simulator may understand and quantify a leak event through physics principals (e.g., conservation equations, equations of state, etc.), but it may be unable to identify the specific leak location. As used herein, the terms numerical simulator, computer model, pipeline simulator, pipeline model, and the like, generally refer to models configured to simulate operational parameters and quantify leaks of a pipeline system. Thus, the terms may be used interchangeably in the following discussion. In some embodiments, artificial intelligence and/or machine learning enhances the models through training and iterative improvements to the models, such as by comparing simulations against measurement data, adjusting for errors or differences between the simulations and measurement data, and so forth.

Accordingly, the present disclosure provides systems and methods to integrate fiber optics and numerical simulators to identify and quantify pipeline leak events. A fiber optic cable may be installed along a pipeline to track fluid flow and noise, identify anomalies, and perform event classification, such as relatively accurate pipeline leak localization. Subsequently, a numerical simulator may utilize a detected leak location from the fiber optic cable along with pressure, temperature, and flowrate measurements at discrete locations along the pipeline (e.g., every 50-kilometers, at the inlet/outlet of pipeline components, etc.) to further evaluate leak size, flowrate, and volume loss, thereby quantifying the severity of the event. Additionally, the fiber optic cable may enable the detection of smaller leaks than numerical simulation alone (e.g., leaks having a diameter of approximately 2% or less of the pipe diameter), and the numerical simulator may decrease the number of false alarms associated with the fiber optic sensing.

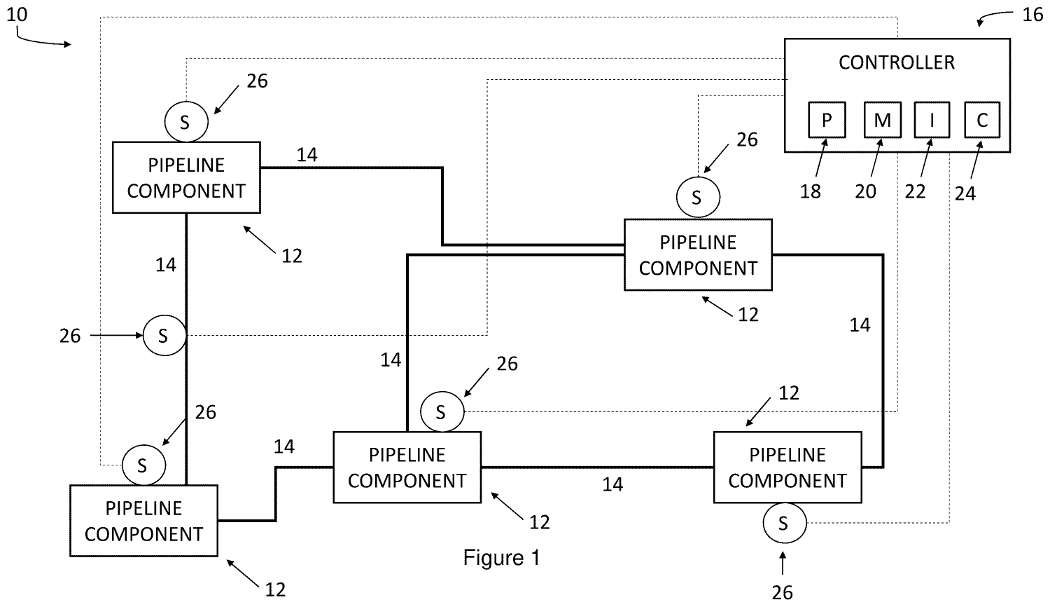

With the forgoing in mind, FIG. 1 is a schematic view of a pipeline system 10 with a number of pipeline components 12 fluidly coupled via fluid conduits or pipes 14 for transporting production fluid (e.g., hydrocarbons, oil, natural gas, etc.). As discussed in further detail below, the pipeline system 10 uses a combination of feedback from fiber optics outside the fluid conduits or pipes 14 and numerical simulations based on sensor feedback inside the fluid conduits or pipes 14 to monitor and control operating of the pipeline system 10. The pipeline system 10 may include any above-ground and/or buried configuration of the fluid conduits or pipes 14. In certain embodiments, the pipeline system 10 may be an above-ground gathering network. Additionally, or alternatively, the pipeline system 10 may be a buried transcontinental oil and gas transmission network. Each pipeline component 12 may represent any suitable hardware component or system, such as one or more of: a well having a wellhead and a Christmas tree coupled to a subterranean reservoir, a substation, a power station, a pump or pump substation, a compressor or compressor substation, a valve, a fluid manifold, a fluid storage facility, a fluid processing facility, a refinery, or any combination thereof. While the illustrative embodiment includes five pipeline components 12, the pipeline system 10 may include additional or fewer pipeline components 12. Likewise, the pipeline system 10 may include additional or fewer pipes 14 (e.g., more or fewer subloops between pipeline components 12). The pipes 14 may be any suitable material (e.g., metal, plastic, composite, etc.), and may include features (e.g., changes in volume, bends, etc.) that affect properties of the production fluid (e.g., flowrate, temperature, pressure, etc.).

The pipeline system 10 also includes a computing system and/or controller 16. The controller 16 includes a processor 18, a memory 20, instructions 22 stored on the memory 20 and executable by the processor 18, and communication circuitry 24. The pipeline system 10 also includes one or more sensors 26 coupled to the pipeline components 12 and/or at discrete points along the pipes 14 (e.g., every 50-kilometers), and communicatively coupled to the controller 16 via the communication circuitry 24. The sensors 26 may include temperature sensors, pressure sensors, flowrate sensors, water content sensors, fluid composition sensors, electrical load sensors, or any combination thereof. In certain embodiments, the sensors 26 may include additional sensors coupled along the pipes 14 (e.g., fiber optic cable installed along the exterior of the pipes 14). In certain embodiments, the controller 16 may be communicatively coupled to one or more of the pipeline components 12 as part of a supervisory control and data acquisition (SCADA) system. Accordingly, the controller 16 may monitory and adjust operations of the one or more of the pipeline components 12 based on sensor feedback from the sensors 26 and/or user inputs.

In certain embodiments, the controller 16 may execute instructions 22 including computer models and/or dynamic simulation software (e.g., pipeline model) to model or simulate operation and various operating parameters (e.g., potential leaks) of the pipeline system 10 based on sensor feedback from the sensors 26 (e.g., measured pressure, temperature, flow rate, fluid composition, and/or water content inside the pipes 14), such that potential leaks may be accurately quantified (e.g., severity of leaks, flow rate of leakage, etc.). Additionally, the controller 16 may execute instructions 22 to process and analyze sensor feedback from fiber optic cables (e.g., external feedback outside the pipes 14) to evaluate operational parameters (e.g., potential leaks) of the pipeline system 10, such that potential leaks may be precisely located along the pipeline system 10 (e.g., precise location within a distance of less than or equal to 1, 2, or 3 meters of any leaks). In certain embodiments, the leak quantification and the leak location information may be integrated to provide a precise leak quantification corresponding to each precise leak location. For example, in some embodiments, the precise leak location may be fed into the computer models and/or dynamic simulation software as a known input, such that the computer models and/or dynamic simulation software outputs the precise leak quantification correlated or matched with the precise leak location. In other words, rather than relying on location predictions in the computer models and/or dynamic simulation software, the precise leak location acquired from the fiber optic cables is used to improve the performance, efficiency, and accuracy of the computer models and/or dynamic simulation software. Thus, the computer models and/or dynamic simulation software may output precise leak information. In some embodiments, the precise leak quantification from the computer models and/or dynamic simulation software and the precise leak location from the fiber optic cables is fed into another computer models and/or numerical simulation software, which uses the information as inputs to analyze the pipeline system 10 and output precise leak information for each of one or more potential leaks along the pipeline system 10. In certain embodiments, the computer models and/or numerical simulation software may include machine learning models configured to learn based on a database of parametric study simulations.

The precise leak information may include the leak quantification (e.g., size, flow rate, volume loss, etc.), leak location, type of leak, criticality of leak, or any combination thereof. The type of leak may include a crack, a seal and/or connection leak (e.g., a seal or connection between pipes 14, pipeline components 12, or the like), an intentional (e.g., vandalism) versus unintentional leak (e.g., corrosion, natural disaster, etc.), or any combination thereof. The size of the leak may include a diameter, a length, a cross-sectional area, or any suitable measurement of the leak size. In the following discussion, reference may be made to a leak diameter, although any suitable size may be used to quantify the leak. The criticality of the leak may indicate whether the leak warrants a warning alert or alarm, a scheduled inspection and/or maintenance, an adjustment to operation of the pipeline system 10 (e.g., reduce pressure and/or flowrate), a shutdown of operations (e.g., close valves), or any combination thereof, performed by the controller 16.

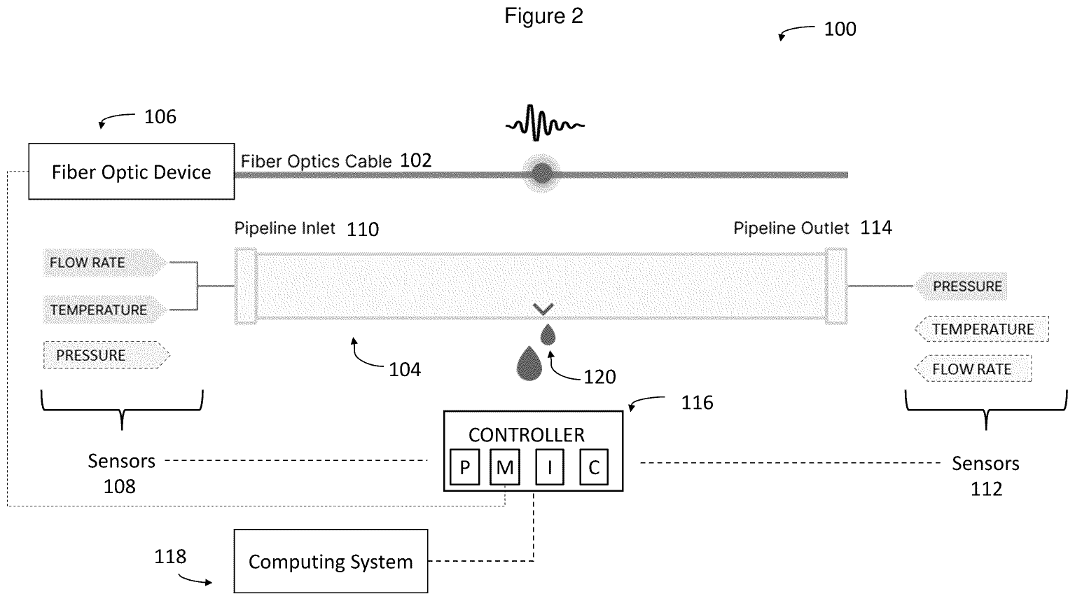

FIG. 2 is a schematic view of a pipeline monitoring system 100 that may be implemented in the pipeline system 10 of FIG. 1, or any other suitable pipeline network or portion of a pipeline network. As shown, the monitoring system 100 includes a fiber optic cable 102 installed along a pipeline 104 and coupled to a fiber optic device 106, a first set of sensors 108 for measuring pressure, temperature, and/or flowrate at the pipeline inlet 110, a second set of sensors 112 for measuring pressure, temperature, and/or flowrate at the pipeline outlet 114, a controller 116 (e.g., controller 16 in certain embodiments) communicatively coupled to the first and second set of sensors 108, 112, the fiber optic device 106, and a computing system 118 (e.g., via wired or wireless connections, or a combination thereof). The controller 116 may include substantially the same components as discussed above regarding the controller 16 (e.g., a processor, a memory, instructions stored on the memory and executed by the processor, and communication circuitry). Additionally, the controller 116 may establish controls on the pressure, temperature, and flowrate at the pipeline inlet 110 and the pipeline outlet 114, may share sensor feedback from the first and second set of sensors 108, 112 and the fiber optic device 106 with the computing system 118, and may adjust operations of one or more pipeline components in response to the sensor feedback and/or user input. In the illustrated embodiment, inlet flowrate, inlet temperature, and outlet pressure are controlled parameters indicated by solid boxes, while inlet pressure, outlet temperature, and outlet flowrate are properties that vary based on fluid dynamics conditions indicated by dashed boxes.

The fiber optic cable 102 may be installed along the exterior of the pipeline 104. For example, as discussed above, the fiber optic cable 102 may be embedded or placed in close proximity to a material which is affected by the presence of the production fluid (e.g., hydrocarbons, oil, natural gas, etc.), such as any suitable polymer, metal, ceramic, gel, or combination thereof, and the like. The material may be applied as a coating to the fiber optic cable 102, and may undergo a change such as swelling, shrinking, dissolving, or any other suitable reaction in response to the presence of the fluid. The change in the material may affect the fiber optic cable 102 by increasing or reducing the strain on the fiber 102, or by causing a chemical reaction with the fiber 102 (e.g., resulting in a temperature change).

Further, the fiber optic cable 102 may be coupled to the fiber optic device 106. The fiber optic device 106 may act as a measurement device for fiber optic sensing, and may include laser sources, modulators, receivers and acquisition electronics, in conjunction with processing and memory circuitry to calculate the value of a measurement. Light may be sent through the fiber optic cable 102 by the fiber optic device 106 (e.g., via the laser sources), changes in stresses on the fiber optic cable 102 (e.g., from changes in the coating material) may be measured by measuring changes in the wavelength of the light returned by the fiber optic cable 102, the changes in the wavelength of the light returned may be used to calculate the temperature along the pipeline 104, and temperature anomalies can be correlated to the presence of a leak 120 in the pipeline 104. Additionally, changes in the intensity of wavelength-shifted light returned by the fiber optic cable 102 may provide insight into the strain on the fiber optic cable. For example, any suitable technique may be used to measure the change in stress and the corresponding changes in the optical characteristics of the fiber optic cable 102, such as optical frequency domain reflectometry, detection of change in attenuation or index of refraction of the fiber optic cable 102, optical time domain reflectometry (OTDR), frequency domain techniques, Brillouin, Raman or Rayleigh scattering, and the like. Accordingly, when pipeline leakage occurs and hydrocarbon fluid affects the coating material, the fiber optic cable 102 and fiber optic device 106 may detect acoustic and temperature anomalies associate with the leak 120. While only one fiber optic device 106 is shown in FIG. 2, there may be a plurality of fiber optic devices deployed along the pipeline 104 (e.g., each 10, 20, 30, 40, 50 kilometers) for fiber optic sensing.

Due to the continuous nature of the fiber optic cable 102 (e.g., the fiber optic cable 102 spans the entire length of the pipeline 104), the fiber optic cable 102 may be used to detect and pinpoint a relatively accurate location of the leak 120 (e.g., within a few meters of the true leak location). Additionally, the monitoring system 100 may classify the detected event (e.g., as a digging, drilling, excavator, fiber break, pigging, etc. event) and generate a generally event severity level (e.g., low, medium, high) based on thresholds associated with anomaly levels by processing real time acoustic and temperature data from the fiber optic cable 102 and the fiber optic device 106 using sophisticated analytical workflows and machine learning techniques. However, the monitoring system 100 may not be able to physically interpret the severity of the leak event (e.g., evaluate leak size, flowrate, and volume loss) using the fiber optic cable 102 and fiber optic device 106 alone. Accordingly, the monitoring system 12 also includes the first set of sensors 108, the second set of sensors 112, and the computing system 118 in order to perform dynamic numerical simulations.

The computing system 118 may include substantially the same components as discussed above regarding the controller 16 (e.g., a processor, a memory, instructions stored on the memory and executed by the processor, and communication circuitry), as well as additional components, such as a display (e.g., user interface). The computing system 118 may be any suitable computing device that is capable of communicating with other devices and processing data in accordance with the techniques described herein. For example, in certain embodiments, the computing system 118 may be a cloud-based computing system that includes a number of computers that may be connected through a real-time communication network, such as the Internet. In one embodiment, large-scale analysis operations may be distributed over the computers that make up the cloud-based computing system. It should be noted that the computing system 118 may also be implemented in a single computing device, such as a laptop, notebook, desktop, tablet, HMI, or workstation computer, as well as a server type device or portable, communication type device, such as a cellular telephone and/or any other suitable computing device. While the illustrative embodiment includes the controller 116 and the computing system 118, certain embodiments may include a single controller. In such embodiments, the controller may perform substantially the same processes as described above regarding the controller 116 as well as those described below regarding the computing device 118.

The computing system 118 may locally and/or remotely access and execute software packages for dynamic numerical simulation. For example, the computing system 118 may store the software packages as instructions on the memory and/or access the software packages via the communication circuitry and a real-time communication network, such as the Internet, and execute the software packages by the processor. The computing system 118 may generate a base simulation case in which no leak is present prior to the monitoring system 100 initiating leak detection. The computing system 118 may generate the base simulation case using physics principals (e.g., conservation of mass) and basic parameters of the pipeline 104, such as fluid composition and PVT properties (e.g., pressure, specific volume, temperature) of the production fluid being transported, characteristics and geometry of the piping flow path (e.g., diameter, length, etc.), and/or controls on the pressure, temperature, and flowrate at the pipeline inlet 110 and the pipeline outlet 114. During operation of the pipeline 104, the computing system 118 may receive sensor feedback from the first set of sensors 108 and the second set of sensors 112, via the controller 116, to calibrate the base simulation case such that simulated values output from the simulation substantially match the measured sensor data. Accordingly, the base simulation case may function as a real-time model of the pipeline 104 under normal operation (e.g., with no leak present).

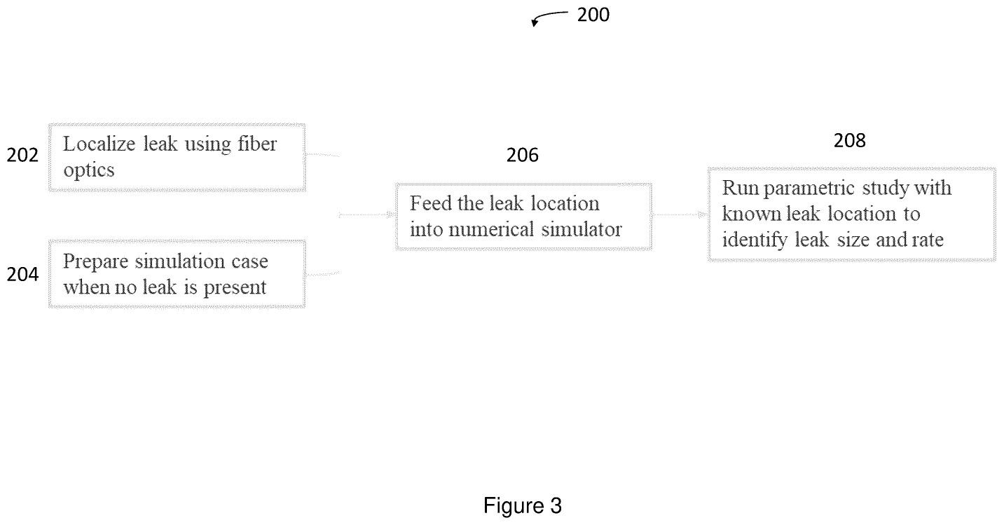

Therefore, the monitoring system 100 may integrate fiber optic sensing and numerical simulation techniques to detect and quantify pipeline leaks. For example, the monitoring system 100 may prepare a base simulation case when no leak is present using the computing system 118, perform event classification and/or leak localization using the fiber optic cable 102 and the fiber optic device 106, feed the determined leak location into a numerical simulator, and run a parametric study with the detected leak location to identify the leak size and flowrate. Additional details with regard to detecting and quantifying pipeline leaks will be described with reference to FIG. 3.

With the foregoing in mind, FIG. 3 illustrates a block diagram of a process 200 for integrating fiber optics and numerical simulation, in accordance with embodiments described herein. Although the following description of the process 200 is described in a particular order, which represents a particular embodiment, it should be noted that the process 200 may be performed in any suitable order. Moreover, although the following description of the process 200 is described as being performed by the monitoring system 100, it should be noted that the process 200 may be performed by any suitable computing device.

Referring now to FIG. 3, at block 202, the monitoring system 100 may localize the leak 120 using fiber optic sensing (e.g., determine leak location of the leak 120). Prior to initiating leak detection, the fiber optic cable 102 may be installed along the exterior of the pipeline 104 as a distributed acoustic sensing (DAS) system that enables continuous, real-time measurements along the length of the fiber optic cable 102, and thus, along the length of the pipeline 104. For example, the fiber optic device 106 may send a short pulse of light into the fiber optic cable, the pulse of light may return to the fiber optic device 106 as light backscatter after traveling through the fiber optic cable 102, and changes in the wavelength and/or intensity of the returned light may be used to calculate the temperature along the pipeline 104 and/or strain on the fiber optic cable 102. Further, the fiber optic device 106 may send light pulses through the fiber optic cable 102 repeatedly to generate a space-time image of acoustic events along the fiber optic cable 102. As discussed above, a coating may be applied to the fiber optic cable 102 that reacts to the presence of the production fluid (e.g., hydrocarbons, oil, natural gas, etc.). The reaction between the coating and the production fluid may affect the fiber optic cable 102 by increasing or reducing the strain on the fiber 102, or by causing a chemical reaction with the fiber 102 (e.g., resulting in a temperature change). Accordingly, when pipeline leakage occurs and the production fluid affects the coating material, the fiber optic cable 102 and fiber optic device 106 may detect acoustic and temperature anomalies associate with the leak 120.

Further, the real-time acoustic and temperature data from the fiber optic cable 102 may be processed with sophisticated analytical workflows and machine learning techniques to determine a detected event type, a general event severity, and an event location associated with the leak 120. The detected event type may be classified as a digging, drilling, excavator, fiber break, pigging, and the like, event where the magnitude and location of the acoustic or temperature anomaly may be used, along with characteristics of the pipeline 104 (e.g., if the pipeline is part of an above-ground gather network or a buried transcontinental oil and gas transmission pipeline, etc.), to classify the event type. The general event severity may be broadly classified as low, medium, or high. This classification may not have a direct physics implication (i.e., be based on physics principals such as conservation equations and equations of state). Rather, the general event severity may be determined based on threshold values associated with the anomaly level (e.g., magnitude of the acoustic and/or temperature anomaly). The event location may be determined based on the space-time image of acoustic events along the fiber optic cable 102, and may be substantially accurate (e.g., within 1-2 meters of the true leak location).

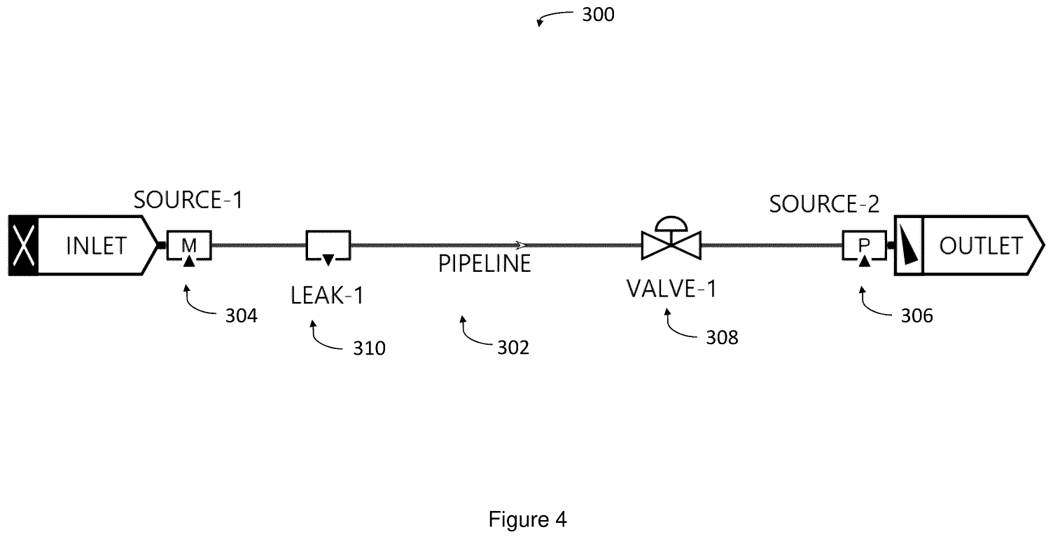

At block 204, the monitoring system 100 may prepare a representative simulation of the pipeline 104 when no leak is present. For example, the computing system 118 may execute one or more software packages for dynamic numerical simulation to generate a base simulation case in which no leak is present. The computing system 118 may generate the base simulation case using physics principals (e.g., conservation of mass) and basic parameters of the pipeline 104. For example, the composition and PVT properties (e.g., pressure, specific volume, temperature) of the production fluid, characteristics and geometry of the pipeline 104 flow path (e.g., diameter, length, etc.), and/or controls on the pressure, temperature, and flowrate at the pipeline inlet 110 and the pipeline outlet 114 may be used as inputs to define the base simulation case. During operation of the pipeline 104, the computing system 118 may receive sensor feedback from the first set of sensors 108 and the second set of sensors 112, via the controller 116, to calibrate the base simulation case such that simulated values output from the simulation substantially match the measured sensor data. Accordingly, while FIG. 3 shows blocks 202 and 204 occurring at the same time in the workflow, it should be noted that the base simulation may be prepared prior to leak detection (e.g., before the monitoring system 100 is deployed, while the fiber optic cable 102 is being installed, etc.) to insure proper calibration of the base simulation case. Therefore, the base simulation case may function as a real-time model of the pipeline 104 under normal operation (e.g., with no leak present). Additional details with regard to a base simulation case will be described with reference to FIG. 4.

When a leak event is detected by fiber optic sensing at block 202, the monitoring system 100 may report a relatively accurate leak location. However, the monitoring system 100 cannot physically interpret the size of the leak 120 and the severity of the event using fiber optic sensing alone. Conversely, the monitoring system 100 may utilize numerical simulation to understand the event through physics (e.g., evaluate leak size, flowrate, and volume loss), but would be unable to reliably predict the leak location based on numerical simulation alone.

For example, in a simple case where the leak back pressure (i.e., ambient pressure) and discharge coefficient parameters are fixed, the numerical simulator (e.g., software executed by the computing system 118, or any other suitable computing device) may attempt to run a parametric study that varies both the diameter and the section associated with the leak 120. For example, the numerical simulator may vary the leak diameter between 0.002 meters and 0.04 meters in 20 intervals (e.g., increasing the diameter by 0.002 until reaching 0.04 meters), and may divide the total pipeline length into 20 sections (e.g., each section is two meters long) and vary the section associated with the leak location, thus creating a parametric study of 20×20=400 cases. Accordingly, it would be computationally intensive (e.g., time consuming, power intensive, etc.) to run this parametric study. Additionally, it would be challenging to identify the most probable scenario out of the 400 cases, which may dilute the accuracy of the inversion problem (i.e., the numerical simulation to detect a leak location). In this example, by feeding a leak location into the numerical simulator (e.g., by fixing the section based on a leak location determined using fiber optic sensing), the numerical simulator would only need to run 20 cases. In many cases, the behavior of pressure and flowrate under various leak diameters may exhibit monotonic behavior (i.e., strictly increasing or decreasing), which significantly reduces the inversion uncertainty. Accordingly, feeding the leak location into the numerical simulator increases the accuracy of the results (e.g., the predicted leak diameter) while decreasing the computational intensity (e.g., decreasing the number of cases, thus decreasing the required computing time and power).

Therefore, at block 206, the monitoring system 100 may feed the leak location determined using fiber optic sensing into the numerical simulator that was used to generate the base simulation case to decrease the size of the parametric study and the inversion uncertainty. It should be noted that while the leak back pressure (i.e., ambient pressure) and discharge coefficient parameters were fixed in the example discussed above, in more complicated flow simulations these parameters may need to be included (e.g., varied) in the parametric study. For example, a parametric study could include a 4-dimensional matrix with six variants each of back pressure (e.g., ranging from 0 to 10 bars, in intervals of 2 bars), discharge coefficient (e.g., ranging from 0.6 to 0.9, in intervals of 0.05), leak diameter (e.g., ranging from 0.004 to 0.04 meters, in intervals of 0.004), and section (ranging from 2 to 18, in intervals of 2 sections). In this example, the parametric study includes 6\hat{ }4=1296 cases and includes variation of the section associated with the leak location, however the number of cases may be less than if the leak location was a desired output. That is, since the leak location is known using fiber optic sensing, the numerical simulator can vary the section number to create a square parametric matrix (thereby allowing for simpler computations), while examining fewer sections (e.g., 6 rather than 20).

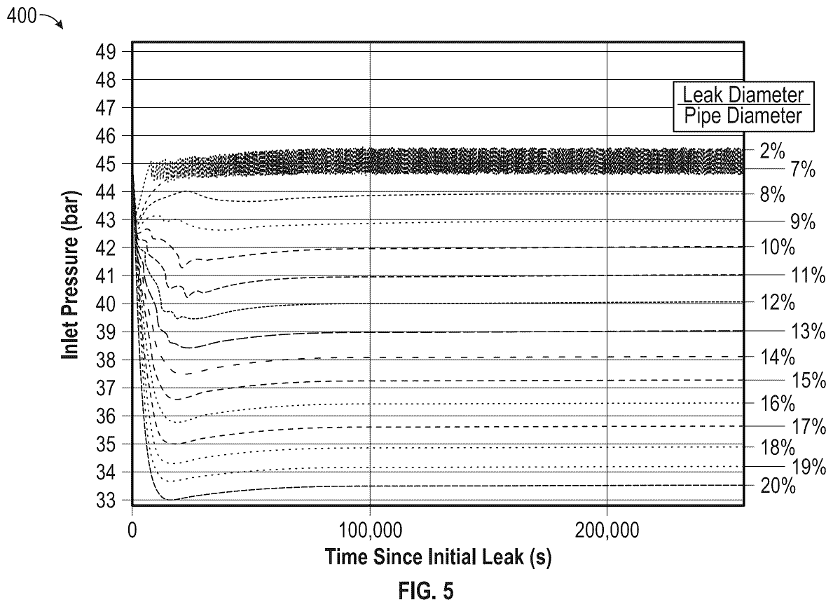

At block 208, the monitoring system 100 may run the parametric study with the known leak location to identify the leak size (e.g., diameter) and rate (e.g., flowrate). That is, the monitoring system 100 may use conservation equations, equations of state, and other physics principals to generate a model with the parameter matrix defining varying leak and flow path parameters. After running the model with the parameter matrix, a series of simulated properties (e.g., outputs from the model) may be compared with actual measurements (e.g., sensor feedback from the first and second set of sensors 108, 112) to identify the most plausible scenario (e.g., leak diameter, leak flow rate). For example, in scenarios where the inlet flowrate and outlet pressure are being controlled, the monitoring system 100 may generate simulated results of the inlet pressure and outlet flowrate under various leak diameters, and compare the simulated values to the measured data to determine the most probable leak diameter (e.g., the leak diameter with simulated values most closely matching measured data). Additional details with regard to comparing simulated values to measured values will be described with reference to FIGS. 5-8.

With the foregoing in mind, FIG. 4 schematically illustrates an example simulation case 300 for pipeline leak monitoring using the process 200 of FIG. 3, in accordance with embodiments described herein. While the simulation case 300 is described with specific parameters, which may reflect a specific embodiment, it should be noted that simulation cases with different parameters may be generated in accordance with the process 200. For example, more complex (e.g., including additional parameters, more complicated flow path geometry, etc.) simulation cases may be generated.

Referring now to FIG. 4, the simulation case 300 includes a simple piping structure 302 with a pure CO2 component (e.g., production fluid). The piping structure 302 may be defined in the simulation case 300 using a number of input parameters, such as length, elevation, diameter, roughness, number of segments used for plotting results, and piping wall material parameters such as capacity, conductivity, density, and the like. For example, the piping structure 302 may have a length of 40 kilometers, an elevation of 0 meters, a diameter of 0.2 meters, a roughness of 2.8e-5 meters, 20 segments for plotting results, and appropriate piping wall material parameters. Further, the simulation case 300 may include inlet control 304 and outlet control 306. In the illustrated embodiment, the inlet control 304 is controlling the mass flowrate and the temperature. Accordingly, the simulation case 300 may define the inlet control 304 as setting and maintaining the inlet temperature as 10 degree Celsius and the mass flowrate as 15 kilograms/second. Likewise, in the illustrated embodiment, the outlet control 306 is controlling the pressure driven (e.g., outlet pressure). For example, the simulation case 300 may define the outlet control 306 as setting and maintaining the outlet pressure as 20.68 bar.

Additionally, the piping structure 302 includes a control valve 308 and a leak source 310. The control valve 308 may control the fluid flow through the piping structure 302. The leak source 310 may be associated with the fluid flow controlled by the control valve 308. The simulation case 300 may simulate a variety of leak scenarios by running a parametric study that varies leak source 310 parameters. For example, the parametric study may vary the leak location between section 1 and section 20 and may vary the equivalent diameter of leak area between 0.002 to 0.04 meters (i.e., between 1% to 20% of the pipe diameter). As discussed above, the parametric study may fix the leak back pressure and the discharge coefficient parameters. For example, the leak back pressure may be set as 0 bar and the discharge coefficient may be set as 0.84. Alternatively, the parametric study may vary the leak back pressure (e.g., between 0 to 10 bar) and the discharge coefficient (e.g., between 0.6 to 0.9), and thus may include a 4-dimensional parameter matrix. When the simulation case 300 is initially generated as a base simulation case (e.g., a representative simulation of the pipeline with no leak), the leak source 310 is set as a dummy variable with a leak diameter of 0.

The simulation case 300 may run the parametric study to generate a series of simulated physical properties (e.g., inlet pressure, outlet flowrate, leak flow rate, etc.) for each case (e.g., combination of leak source 310 parameters), which may then be compared against measured data to determine the most probable scenario (e.g., leak diameter, leak flowrate). For example, FIGS. 5-8 illustrate graphs of simulated values from simulation case 300. FIGS. 5-8 illustrate that the simulated physical properties vary substantially based on leak diameter. Accordingly, the most plausible leak size may be determined by performing a similarity analysis (e.g., pattern recognition) between the simulated curves and the actual measurements.

FIG. 5 is a graph 400 of inlet pressure over time since initial leak (i.e., the time when the leak was first detected) for the simulation case 300 of FIG. 4 with leak diameters ranging from 2% to 20% of pipeline diameter. The graph 400 shows that when there is no leak (e.g., leak diameter of 0), the inlet pressure is around 45 bar, and as the leak becomes larger (e.g., increases from 2% to 20% of the pipe diameter), the inlet pressure drops gradually to approximately 33.5 bar. In this simple case, the correlation between inlet pressure and leak diameter is monotonic (i.e., inlet pressure decreases as leak diameter increases). However, the correlation may be more complex for other simulation cases. Further, graph 400 illustrates that the inlet pressure curves from the simulation 300 vary noticeably based on leak diameter. That is, the inlet pressure curves for each leak diameter case do not substantially overlap with any other inlet pressure curve. This is generally true for all simulations (e.g., curves will behave uniquely based on leak diameter, even when the correlation between physical property and leak diameter is not monotonic). Accordingly, the monitoring system 100 (e.g., via computing system 118 or any suitable computing device) may perform a similarity analysis between the simulated inlet pressure curves of graph 400 and the measured inlet pressure over time (e.g., gathered using the first set of sensors 108 and stored in the memory of the controller 116) to determine which simulated inlet pressure curve most closely matches the measured values, and thus the most probable leak diameter.

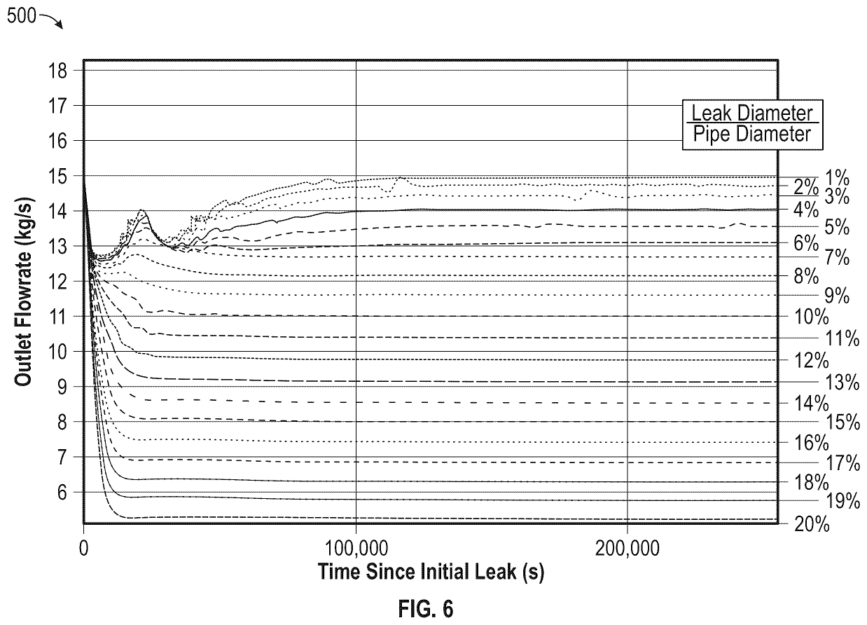

FIG. 6 is a graph 500 of outlet flowrate over time since initial leak for the simulation case 300 of FIG. 4 with a range of different leak diameters (e.g., 1% to 20% of pipeline diameter). As with the inlet pressure curves of graph 400, the outlet flowrate curves of graph 500 do not substantially overlap with any other outlet flowrate curve. Since the outlet flowrate curves from the simulation 300 vary noticeably based on leak diameter, the monitoring system 100 (e.g., via computing system 118 or any suitable computing device) may perform a similarity analysis between the simulated outlet flowrate curves of graph 500 and the measured outlet flowrate over time (e.g., gathered using the second set of sensors 112 and stored in the memory of the controller 116) to determine which simulated outlet flowrate curve most closely matches the measured values, and thus the most probable leak diameter.

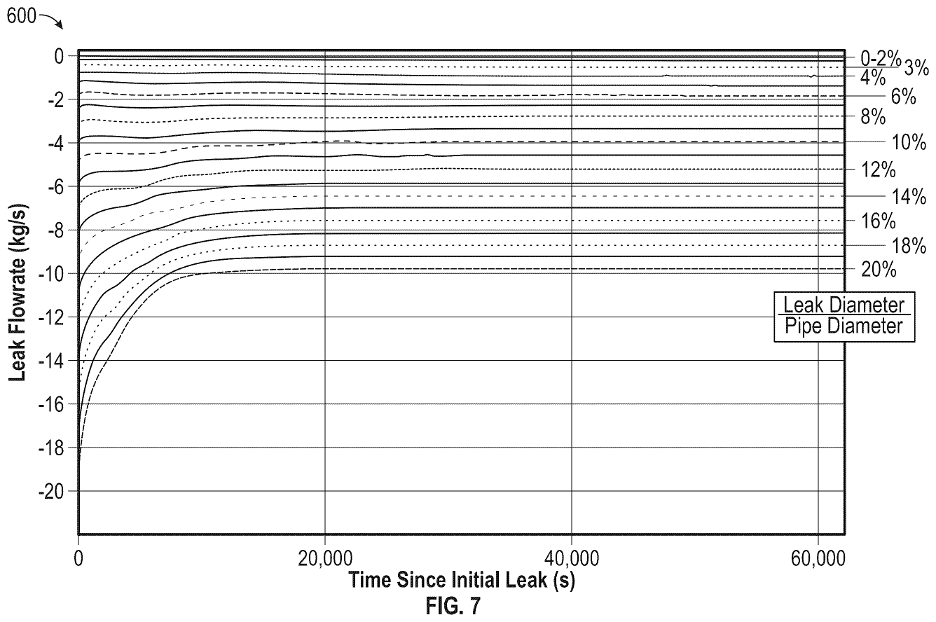

FIG. 7 is a graph 600 of leak flowrate over time since initial leak for the simulation case of FIG. 4 with a range of different leak diameters (e.g., 0-2% to 20% of pipeline diameter). As with the curves of graph 400 and graph 500, the leak flowrate curves of graph 600 do not substantially overlap with any other leak flowrate curve. Since the leak flowrate curves from the simulation 300 vary noticeably based on leak diameter, the monitoring system 100 (e.g., via computing system 118 or any suitable computing device) may perform a similarity analysis between the simulated leak flowrate curves of graph 600 and the leak flowrate over time calculated using measured values (e.g., gathered using the first and second set of sensors 108, 112, calculations executed by the processor and stored in the memory of the controller 116) to determine which simulated leak flowrate curve most closely matches values derived from measured data, and thus the most probable leak diameter.

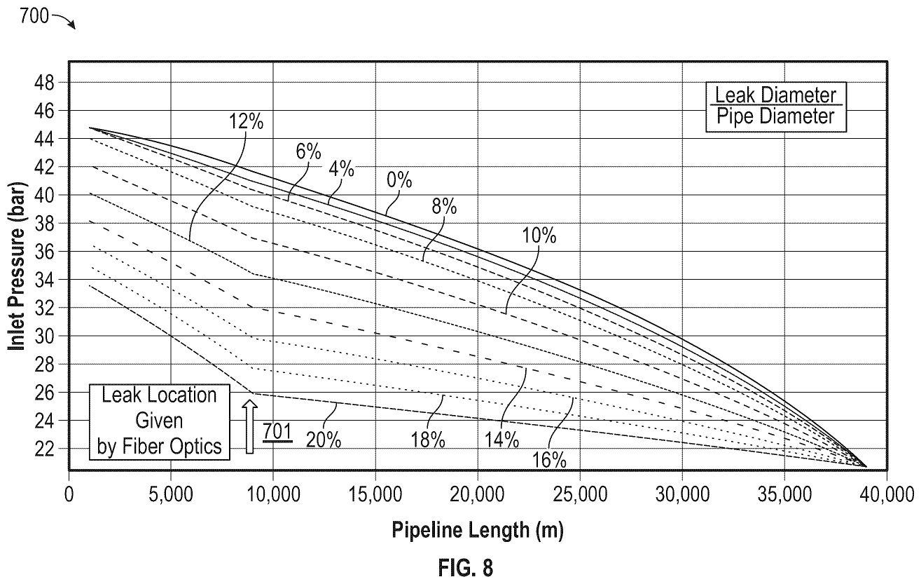

While the graphs of FIGS. 5-7 (e.g., graphs 400, 500, and 600) may be compared to measured values from the inlet and outlet of the pipeline, certain embodiments may include additional sensors along the length of the pipeline (e.g., every 10, 20, 30, 40, 50, etc. kilometer). Accordingly, the simulated physical properties from simulation case 300 (or any other simulation generated using the disclosed techniques) may be compared against additional measured data along the pipeline. For example, FIG. 8 is a graph 700 of pressure variation along the pipeline of the simulation case 300 with a range of different leak diameters (e.g., 0% to 20% of pipeline diameter) under steady state conditions. As indicated by arrow 701, there is a noticeable change in behavior of the pressure along the pipeline at the leak location. That is, for the simulation case 300, the pressure decreases at a faster rate approaching the leak location (with larger leak diameters correlating to a faster decrease in pressure approaching the leak location), and at a more gradual rate leaving the leak location (with larger leak diameters correlating to a more gradual pressure decrease leaving the leak location). Further, since the pressure along the pipeline curves from the simulation 300 vary noticeably based on leak diameter, the monitoring system 100 (e.g., via computing system 118 or any suitable computing device) may perform a similarity analysis between the simulated pressure along the pipeline curves of graph 700 and measured values (e.g., gathered using the additional sensors along the pipeline, stored in the memory of the controller 116) to determine which simulated pressure along the pipeline curve most closely matches the measured values. Accordingly, sensor feedback from any location along the pipeline may be used to confirm the most plausible leak size.

The monitoring system 100 may perform comparisons between simulated values from the simulation case 300 and measured values from discrete sensors along the respective pipeline using one or more of the curves from FIGS. 5-8. For example, the monitoring system may perform an initial comparison between simulated inlet pressure values and measured inlet pressure values to determine the most probable leak size, and then perform one or more additional comparisons (e.g., between simulated and measured values of outlet flowrate, leak flowrate, etc.) to cross validate (e.g., confirm) the most probably leak size.

Further, when none of the simulated values substantially match the measured values, the monitoring system 100 may generate a notification (e.g., via a display of the computing system 118) indicating that the leak detected by fiber optic sensing (e.g., via fiber optic cable 102 and fiber optic device 106) may be a false alarm. For example, the notification may include a pop-up window that requires user input to either accept the leak alarm as a true alarm (e.g., when a simulated inlet pressure curve substantially matches the measured inlet pressure data, thus validating the leak detection from fiber optic sensing) or dismiss the alarm as a false alarm (e.g., when no simulated inlet pressure curve substantially matches the measured inlet pressure data). When the user accepts the alarm as a true alarm (i.e., acknowledges that a leak has been detected and quantified), a controller associated with the pipeline (e.g., controller 16, controller 116) may adjust operations of one or more pipeline components 12 to mitigate the impact of the leak (e.g., close a normally open valve upstream of the leak to stop fluid flow to the damaged portion of the pipeline) and/or to prepare the pipeline for maintenance events. When the user dismisses the alarm, the monitoring system 100 may return to leak detection (e.g., fiber optic cable 102 and fiber optic device 106 may continue to take measurements to detect any leakage events, the computing system 118 may generate base simulation cases, etc.). Accordingly, the monitoring system 100 may improve (e.g., decrease) the response time for resolving a pipeline leakage event, as well as the number of false alarms.

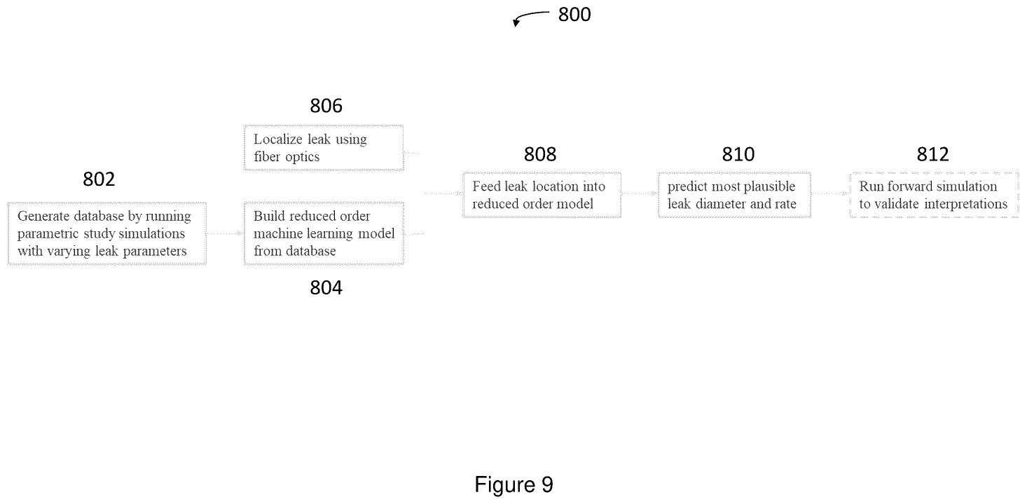

The leak detection response time may be further reduced by generating a large database in advance (e.g., prior to the deployment of the monitoring system 100) and running a single reduced order model when a leak event is detected, as opposed to running extensive parametric studies. Accordingly, FIG. 9 illustrates a block diagram of an alternative/additional process 800 for integrating fiber optics and numerical simulation in real time by generating reduced order models, in accordance with embodiments described herein. Although the following description of the process 800 is described in a particular order, which represents a particular embodiment, it should be noted that the process 800 may be performed in any suitable order. Moreover, although the following description of the process 800 is described as being performed by the monitoring system 100, it should be noted that the process 800 may be performed by any suitable computing device.

Referring now to FIG. 9, at block 802, any suitable computing system associated with and/or included in the monitoring system 100 (e.g., computing system 118) may generate a database populated with numerous simulated physical properties by running multiple (e.g., hundreds, thousands, etc.) parametric studies prior to deployment of the monitoring system 100 (e.g., before the monitoring system 100 begins leak detection). For example, the computing system 118 may execute one or more software packages for dynamic numerical simulation to generate a base simulation case with no leak is present for a specific pipeline facility (e.g., pipeline system 10). The computing system 118 may generate the base simulation case using physics principals (e.g., conservation of mass) and basic parameters of the pipeline facility. That is, the composition and PVT properties (e.g., pressure, specific volume, temperature) of the production fluid (i.e., the fluid being transported by the pipeline facility), characteristics and geometry of the flow path of the pipeline facility (e.g., diameter, length, etc.), and/or controls on the pressure, temperature, and flowrate at the inlet and outlet of the pipeline facility may be used as inputs to define the base simulation case.

Once the base case is generated, the computing system 118 may generate the database of simulated physical properties by running thousands of parametric study simulations with varying leak diameter, leak location, leak back pressure, and discharge coefficients. Although reference is made to a leak diameter, any suitable measure of leak size (e.g., diameter, length, cross-sectional area, etc.) is applicable to the process 800 of FIG. 9. In certain embodiments, the parametric studies may vary the back pressure between 0 to 10 bar, the discharge coefficient between 0.6 to 0.9, the leak diameter between 0.004 to 0.04 meters, and the leak location between section 2 and section 18, where each section corresponds to an equidistant interval along the pipeline (e.g., a 40-kilometer pipeline may be segmented into 20 sections of 2 kilometers each, with the section number increasing going from the inlet to the outlet). In this example, the outputs of the multiple parametric studies may include simulated values of inlet pressure, outlet flowrate and temperature, and leak rate as functions of time. Additionally, this example assumes that the inlet flowrate and the outlet pressure are relatively stably controlled within a given period of time. However, when operational conditions deviate from the control parameters (e.g., when the inlet and outlet controls are changed), the simulation database should be rebuilt. That is, the simulation database is calibrated using the inlet and outlet controls of the pipeline facility, and thus is only applicable (e.g., representative of the pipeline facility) under those controls.

At block 804, any suitable computing system associated with and/or included in the monitoring system 100 (e.g., computing system 118) may build a reduced order machine learning model from the database. That is, the computing system 118 may use the database to train a reduced order machine learning model to generally capture the trends of the numerical simulations described in the database, while reducing the computational complexity. The machine learning model may be used to predict leak information (e.g., quantify a detected leak). Therefore, the machine learning model has the reverse input and output of the parametric studies. That is, while the numerical simulations used to generate the database use leak parameters (e.g., leak diameter, leak rate, back pressure, and discharge coefficient) to generated simulated values of physical properties of the pipeline facility flow path (e.g., inlet pressure, outlet flowrate and temperature variation over time, leak location), the machine learning model uses physical properties of the pipeline facility flow path to predict leak parameters.

At block 806, once the monitoring system 100 begins leak detection for the pipeline facility, the monitoring system 100 may localize the leak using fiber optic sensing using substantially the same process as described above in regards to block 202 of FIG. 3. That is, a fiber optic cable (e.g., fiber optic cable 102) may be installed along the exterior of a pipeline of the pipeline facility as a distributed acoustic sensing (DAS) system that enables continuous, real-time measurements along the length of the pipeline. When pipeline leakage occurs, the production fluid may interact with the fiber optic cable and change the strain and/or temperature of the fiber optic cable. Accordingly, the fiber optic cable may detect acoustic and temperature anomalies associate with the leak. Further, the real-time acoustic and temperature data from the fiber optic cable may be processed with sophisticated analytical workflows and machine learning techniques to determine a detected event type, a general event severity, and an event location associated with the leak. The magnitude and location of the temperature and/or acoustic anomaly may be used, along with characteristics of the pipeline facility (e.g., if the pipeline facility is an above-ground gather network or a buried transcontinental oil and gas transmission pipeline, etc.), to classify the detected event as a digging, drilling, excavator, fiber break, or pigging event. The general event severity may be broadly classified as low, medium, or high. This classification may not have a direct physics implication (i.e., be based on physics principals such as conservation equations and equations of state). Rather, the general event severity may be determined based on threshold values associated with the anomaly level (e.g., magnitude of the acoustic and/or temperature anomaly). The event location may be determined based on a space-time image of acoustic events along the fiber optic cable 102, and may be substantially accurate (e.g., within 1-2 meters of the true leak location).

At block 808, the monitoring system 100 may feed the detected leak location from block 806 into the reduced order machine learning model. Additionally, measured values of inlet pressure, outlet flowrate, and outlet temperature over time may be fed into the reduced order machine learning model (e.g., from a controller of the pipeline facility). Using these inputs, at block 810, the reduced order machine learning model may predict the most plausible leak diameter and leak flow rate. Since the reduced order machine learning model is built using multiple parametric studies from numerical simulations using conservation equations, equations of state, and other physics principals, it may predict the most plausible leak diameter and leak flow rate by comparing the inputted measured values to simulated values associated with various leak diameters and flow rates, and output the leak diameter and flow rate with the most similar simulated values to the measured values. This process may be less computationally complex and time consuming than running the numerical simulations in real-time as leaks are detected, as the thousands of calculations defining the relationships between physical flow path properties (e.g., inlet pressure, outlet flowrate and temperature variation over time, leak location) and the leak parameters (e.g., leak diameter, leak rate, back pressure, and discharge coefficient) do not have to be carried out in real-time.

At block 812, the monitoring system 100 may optionally use the predicted results to run an additional forward model to further validate the interpretations (e.g., the predicted leak diameter and flowrate). For example, the monitoring system 100 may generate a forward model by performing the calculations used to generate the database (e.g., conservation equations, equations of state, etc.) with the predicted leak diameter and flowrate to determine expected values for the inlet pressure, outlet flowrate, outlet temperature, and leak location. When the expected values from the forward model substantially match the measured values for inlet pressure, outlet flowrate, outlet temperature and the detected leak location for block 806, the interpretations are validated. Conversely, when the expected values from the forward model do not substantially match the measured values for inlet pressure, outlet flowrate, outlet temperature and the detected leak location for block 806, the interpretations may be flagged as inconsistent. Additionally, the forward model may be used to forecast upcoming variations. That is, the forward model may predict changes in the leak diameter and/or flow rate based on the expected values.

The monitoring system 100 may generate an alert based on the results from block 812. That is, when the interpretations do not substantially match the expected values from the forward model, the monitoring system 100 may generate a notification (e.g., via a display of the computing system 118) indicating that the database may need to be rebuilt (e.g., that operating conditions of the pipeline facility have changed, thus making the database and reduced order model inaccurate) and/or that the leak detected by fiber optic sensing (e.g., via fiber optic cable 102 and fiber optic device 106) may be a false alarm. For example, the notification may include a selectable option(s) to dismiss the alarm as a false alarm (e.g., when there have been no changes to the inlet and outlet controls of the pipeline facility, indicating that the inconsistent results may be caused by a false alarm from the fiber optic sensing), and/or rebuild the database (e.g., when there have been changes to the operation of the pipeline facility requiring a new representative model to be built).

Additionally, or alternatively, the monitoring system 100 may generate an additional/alternative notification indicating that a leak has been detected and quantified. The additional notification may include a summary of the leak detection process (e.g., the predicted leak location from the fiber optic sensing, the predicted leak size and/or flow rate, cross-validation analysis, etc.), as well as a pop-up alarm with selectable options to acknowledge the leak alarm as a true alarm or dismiss the alarm as a false alarm. When the user accepts the alarm as a true alarm (i.e., acknowledges that a leak has been detected and quantified), a controller associated with the pipeline (e.g., controller 16, controller 116) may adjust operations of one or more pipeline components 12 to mitigate the impact of the leak (e.g., close a normally open valve upstream of the leak to stop fluid flow to the damaged portion of the pipeline) and/or to prepare the pipeline for maintenance events. When the user dismisses the alarm, the monitoring system 100 may return to leak detection (e.g., fiber optic cable 102 and fiber optic device 106 may continue to take measurements to detect any leakage events, the computing system 118 may generate base simulation cases and/or rebuild the database, etc.). Accordingly, the monitoring system 100 may improve (e.g., decrease) the response time for resolving a pipeline leakage event, as well as the number of false alarms.

The technical effect of the disclosed embodiments includes integrating fiber optics and numerical simulators to identify and quantify pipeline leak events, thereby improving response time for resolving pipeline leak events while reducing the number of false alarms. Specifically, a fiber optic cable may be installed along a pipeline to track fluid flow and noise, identify anomalies, and perform event classification, such as relatively accurate pipeline leak localization. Subsequently, a numerical simulator may utilize a detected leak location from the fiber optic cable along with pressure, temperature, and flowrate measurements at discrete locations along the pipeline to further evaluate leak size, flowrate, and volume loss, thereby quantifying the severity of the event. The fiber optic cable may enable the detection of smaller leaks than numerical simulation alone (e.g., leaks having a diameter ˜2% or less of the pipe diameter) while reducing the computational complexity of the numerical simulation, and the numerical simulator may decrease the number of false alarms associated with the fiber optic sensing. Additionally, or alternatively, a reduced order machine learning model may be built prior to leak detection to further reduce computational complexity and improve response time.

The subject matter described in detail above may be defined by one or more clauses, as set forth below.

A system includes a fiber optic cable configured to detect one or more first parameters of a leak event along a fluid conduit, and one or more sensors configured to measure one or more second parameters of a fluid flow along the fluid conduit. The system also includes a controller including a processor, a memory, and instructions stored on the memory and executable by the processor to: detect the one or more first parameters of the leak event via the fiber optic cable, measure the one or more second parameters of the fluid flow via the one or more sensors, input the one or more first parameters and the one or more second parameters into a model configured to simulate operation with the fluid conduit, and output leak information corresponding to the leak event via execution of the model.

The system of the preceding clause, wherein the one or more first parameters includes a leak location.

The system of any preceding clause, wherein the leak information includes a leak quantification of the leak event corresponding to the leak location.

The system of any preceding clause, wherein the leak quantification includes a leak size, a leak flow rate, or a combination thereof.

The system of any preceding clause, wherein the one or more first parameters include a leak location, a leak type, and a leak severity.

The system of any preceding clause, wherein the fiber optic cable is configured to couple to an exterior of the fluid conduit.

The system of any preceding clause, wherein the fiber optic cable is configured to extend along a length of the fluid conduit, and wherein the fiber optic cable is configured to measure a distributed temperature along the length of the fluid conduit, one or more characteristics of an acoustic emission along the length of the fluid conduit, or a combination thereof, wherein the fiber optic cable is configured to detect the leak event based on a temperature anomaly, an acoustic anomaly, or both, along the length of the fluid conduit.

The system of any preceding clause, wherein the one or more second parameters include a temperature, a pressure, a flow rate, or a combination thereof.

The system of any preceding clause, wherein the one or more sensors include a plurality of sensors spaced apart from one another over a distance along the fluid conduit.

The system of any preceding clause, wherein the model includes a dynamic numerical simulator, a database of a plurality of simulations of different leak events, a machine learning model, or a combination thereof.

The system of any preceding clause, wherein the model includes a base simulation case representative of one or more operations of the fluid conduit with no leak, and wherein the base simulation case is calibrated based on feedback from the one or more sensors measured prior to leak detection by the fiber optic cable.

The system of any preceding clause, wherein the controller is configured to: run one or more parametric studies with the leak location of the leak event and varying leak event parameters to generate one or more sets of simulated values associated with each variation of leak event parameters, compare the one or more sets of simulated values against the one or more second parameters of the fluid flow measured by the one or more sensors, and determine the leak quantification based on the comparison.

The system of any preceding clause, wherein the leak event parameters include a leak diameter, a leak flow rate, a leak back pressure, a discharge coefficient, or a combination thereof.

The system of any preceding clause, wherein the leak event parameters further include a leak location, and the leak location of the leak event is validated using the one or more parametric studies.

The system of any preceding clause, wherein the controller is configured to control one or more components coupled to the fluid conduit in response to the leak information, output an alert or alarm based on the leak information, or a combination thereof.

The system of any preceding clause, wherein the model is a reduced order machine learning model based on a database of a plurality of simulations with variations in leak parameters.

A method includes detecting one or more first parameters of a leak event via a fiber optic cable along a fluid conduit, and measuring one or more second parameters of a fluid flow along the fluid conduit via one or more sensors. The method also includes inputting the one or more first parameters and the one or more second parameters into a model configured to simulate operation with the fluid conduit, and outputting leak information corresponding to the leak event via execution of the model.

The method of the preceding clause, wherein the one or more first parameters include a leak location, and the leak information includes a leak quantification of the leak event corresponding to the leak location.

The method of any preceding clause, wherein the leak quantification includes a leak size, a leak flow rate, or a combination thereof.

A non-transitory, tangible, computer readable medium includes instructions that, when executed by a processor, causes the processor to perform operations including detecting one or more first parameters of a leak event via a fiber optic cable along a fluid conduit, where the one or more first parameters includes a leak location, and measuring one or more second parameters of a fluid along the fluid conduit via one or more sensors. The operations also include inputting the one or more first parameters and the one or more second parameters into a model configured to simulate operation with the fluid conduit, and outputting leak information corresponding to the leak event via execution of the model, where the leak information includes a leak quantification of the leak event corresponding to the leak location, and where the leak quantification includes a leak size, a leak flow rate, or a combination thereof.

Language of degree used herein, such as terms “approximately,” “about,” generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 5 degrees, 3 degrees, 1 degree or 0.1 degree.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system comprising:
a fiber optic cable configured to detect one or more first parameters of a leak event along a fluid conduit;
one or more sensors configured to measure one or more second parameters of a fluid flow along the fluid conduit; and
a controller comprising a processor, a memory, and instructions stored on the memory and executable by the processor to:
detect the one or more first parameters of the leak event via the fiber optic cable;
measure the one or more second parameters of the fluid flow via the one or more sensors;
input the one or more first parameters and the one or more second parameters into a model configured to simulate operation with the fluid conduit; and
output leak information corresponding to the leak event via execution of the model.

2. The system of claim 1, wherein the one or more first parameters comprises a leak location.

3. The system of claim 2, wherein the leak information comprises a leak quantification of the leak event corresponding to the leak location.

4. The system of claim 3, wherein the leak quantification comprises a leak size, a leak flow rate, or a combination thereof.

5. The system of claim 1, wherein the one or more first parameters comprises a leak location, a leak type, and a leak severity.

6. The system of claim 1, wherein the fiber optic cable is configured to couple to an exterior of the fluid conduit.

7. The system of claim 1, wherein the fiber optic cable is configured to extend along a length of the fluid conduit, and wherein the fiber optic cable is configured to measure a distributed temperature along the length of the fluid conduit, one or more characteristics of an acoustic emission along the length of the fluid conduit, or a combination thereof, wherein the fiber optic cable is configured to detect the leak event based on a temperature anomaly, an acoustic anomaly, or both, along the length of the fluid conduit.

8. The system of claim 1, wherein the one or more second parameters comprises a temperature, a pressure, a flow rate, or a combination thereof.

9. The system of claim 8, wherein the one or more sensors comprises a plurality of sensors spaced apart from one another over a distance along the fluid conduit.

10. The system of claim 1, wherein the model comprises a dynamic numerical simulator, a database of a plurality of simulations of different leak events, a machine learning model, or a combination thereof.

11. The system of claim 1, wherein the model comprises a base simulation case representative of one or more operations of the fluid conduit with no leak, and wherein the base simulation case is calibrated based on feedback from the one or more sensors measured prior to leak detection by the fiber optic cable.

12. The system of claim 3, wherein the controller is configured to:
run one or more parametric studies with the leak location of the leak event and varying leak event parameters to generate one or more sets of simulated values associated with each variation of leak event parameters;
compare the one or more sets of simulated values against the one or more second parameters of the fluid flow measured by the one or more sensors; and
determine the leak quantification based on the comparison.

13. The system of claim 12, wherein the leak event parameters comprise a leak diameter, a leak flow rate, a leak back pressure, a discharge coefficient, or a combination thereof.

14. The system of claim 13, wherein the leak event parameters further comprise a leak location, and the leak location of the leak event is validated using the one or more parametric studies.

15. The system of claim 1, wherein the controller is configured to control one or more components coupled to the fluid conduit in response to the leak information, output an alert or alarm based on the leak information, or a combination thereof.

16. The system of claim 1, wherein the model is a reduced order machine learning model based on a database of a plurality of simulations with variations in leak parameters.

17. A method, comprising:
detecting one or more first parameters of a leak event via a fiber optic cable along a fluid conduit;
measuring one or more second parameters of a fluid flow along the fluid conduit via one or more sensors;
inputting the one or more first parameters and the one or more second parameters into a model configured to simulate operation with the fluid conduit; and
outputting leak information corresponding to the leak event via execution of the model.

18. The method of claim 17, wherein the one or more first parameters comprises a leak location, and the leak information comprises a leak quantification of the leak event corresponding to the leak location.

19. The method of claim 18, wherein the leak quantification comprises a leak size, a leak flow rate, or a combination thereof.

20. A non-transitory, tangible, computer readable medium comprising instructions that, when executed by a processor, causes the processor to perform operations comprising:
detecting one or more first parameters of a leak event via a fiber optic cable along a fluid conduit, wherein the one or more first parameters comprises a leak location;
measuring one or more second parameters of a fluid flow along the fluid conduit via one or more sensors;
inputting the one or more first parameters and the one or more second parameters into a model configured to simulate operation with the fluid conduit; and
outputting leak information corresponding to the leak event via execution of the model, wherein the leak information comprises a leak quantification of the leak event corresponding to the leak location, and wherein the leak quantification comprises a leak size, a leak flow rate, or a combination thereof.
